(19) United States
(12) Patent Application Publication
(10) Pub. No.: US 2015/0045168 A1
(43) Pub. Date: Feb. 12, 2015

(54) PLANETARY GEAR ARRANGEMENT FOR A SEAT ADJUSTMENT MECHANISM AND METHOD FOR OPERATING SUCH A PLANETARY GEAR ARRANGEMENT

(71) Applicant: Ingo Kienke, Wermelskirchen (DE)

(72) Inventor: Ingo Kienke, Wermelskirchen (DE)

(73) Assignee: JOHNSON CONTROLS TECHNOLOGY COMPANY

(21) Appl. No.: 14/115,808

(22) PCT Filed: May 4, 2012
(86) PCT No.: PCT/EP2012/058312

§ 371 Date: Dec. 28, 2013

(30) Foreign Application Priority Data
May 6, 2011 (DE) 10 2011 100 851.2

(51) Int. Cl. B60N 2/02; B60N 2/225

(52) U.S. Cl. CPC B60N 2/0232; B60N 2/2252
USPC 475/149

(57) ABSTRACT

A planetary gear arrangement for a seat adjustment mechanism, includes at least one inner, externally toothed fitting part and an outer, internally toothed fitting part, which fitting parts are pivotable in relation to each other about a pivot axis. An external toothing of the inner, externally toothed fitting part rolls along an internal toothing of the outer, internally toothed fitting part. A plurality of electric magnetizing coils are arranged annularly on the outer, internally toothed fitting part, the magnetizing coils being activatable alternately in an encircling manner in the circumferential direction of the outer, internally toothed fitting part such that the magnetic field of each magnetizing coil acts on the inner, externally toothed fitting part and sets the latter into a rotatory movement relative to the outer, internally toothed fitting part.

The invention relates to a planetary gear arrangement for a seat adjustment mechanism according to the preamble of claim 1. The invention further relates to a method for operating a planetary gear arrangement for a seat adjustment mechanism according to the preamble of claim 9.

In the prior art, planetary gears, such as swash gears, of a seat adjustment mechanism are operated manually or are driven by means of a conventional electric motor and a separate gear mechanism.

WO 2005/013465 A1 describes a motor vehicle actuation drive having switchable stator means for producing magnetic fields, a magnetic element which is movable at least in a radial direction, and means for controlling the switchable stator means.

An object of the present invention is to provide a planetary gear arrangement which is improved over the prior art for a seat adjustment mechanism and an improved method for operating a planetary gear arrangement for a seat adjustment mechanism.

The object is achieved by the features set out in claim 1 with regard to the planetary gear arrangement.

The object is achieved by the features set out in claim 9 with regard to the method for operating a planetary gear arrangement for a seat adjustment mechanism.

The dependent claims relate to advantageous developments of the invention.

In the planetary gear arrangement which comprises at least an inner, externally toothed fitting member and an outer, internally toothed fitting member which can be pivoted relative to each other about a pivot axis, with the inner, externally toothed fitting member being arranged in the outer, internally toothed fitting member in such a manner that an outer toothing of the inner, externally toothed fitting member rolls on an inner toothing of the outer, internally toothed fitting member, a plurality of magnetic coils are arranged annularly according to the invention on the outer, internally toothed fitting member, which coils can be activated so as to rotate alternately in a peripheral direction of the outer, internally toothed fitting member so that the magnetic field thereof acts on the inner, externally toothed fitting member and causes this member to move in rotation relative to the outer, internally toothed fitting member. Advantageously, a structural space and a weight of an electromechanically actuated seat adjustment mechanism are thereby reduced.

The planetary gear arrangement is preferably in the form of an open planetary gear, for example, a swash gear. Such an open planetary gear is a simple planetary gear having only one central wheel and a non-coaxial, rotating connection shaft of a planetary wheel. In one possible embodiment, the central wheel is formed, for example, by the outer, internally toothed fitting member and the planetary wheel is formed by the inner, externally toothed fitting member.

In a particularly advantageous manner, the inner, externally toothed fitting members and the outer, internally toothed fitting members of conventional planetary gears, such as swash gears, can be used so that the production costs of the seat adjustment mechanism are minimized.

In one advantageous embodiment, an absolute positioning and/or a load measurement are possible on the electromechanically actuated seat adjustment mechanism without complex, wearing and cost-intensive additional sensor equipment.

In a particularly advantageous embodiment, a uniformly large torque can be produced at each rotation speed until the electromechanically actuated seat adjustment mechanism stops.

The plurality of magnetic coils are in the form in a particularly preferred manner of a magnetic ring which is a structural unit and can be particularly readily mounted in that manner. The magnetic ring is particularly formed in the manner of a conventional stator ring in which a plurality of magnetic coils are arranged beside each other in the peripheral direction.

Advantageously, conventional planetary gears, such as swash gears, can be subsequently fitted with a magnetic ring which consequently electromechanically actuates existing planetary gears in a cost-effective manner.

In another advantageous embodiment, high retention moments can be produced by means of the planetary gear, in particular the swash gear, having a magnetic ring, so that the electromechanically actuated seat adjustment mechanism is also secured against inadvertent adjustment without a conventional motor brake.

In another advantageous embodiment, particularly high levels of positioning accuracy can be achieved by means of the planetary gear, in particular the swash gear, having a magnetic ring so that the electromechanically actuated seat adjustment mechanism can be adjusted in particularly fine increments.

In a particularly preferred embodiment, an inner periphery of the magnetic ring is formed so as to correspond to the inner, externally toothed fitting member and the swash movement thereof along the inner toothing of the fitting member so that the magnetic ring can be arranged at the front face on the fitting member so as to be fixed to a frame.

In an alternative embodiment, the magnetic ring surrounds the fitting member at the outer side.

In a particularly preferred manner, the fitting members, the magnetic ring and the eccentric shaft are surrounded by a housing which is of bowl-like form and which is retained on the fitting member with the open end thereof in a positive-locking, materially engaging and/or non-positive-locking manner, and protects the surrounded components from contamination and/or damage.

In an advantageous construction variant, a first inner, externally toothed fitting member and a second inner, externally toothed fitting member are connected in a rotationally secure manner, with the outer toothing of the first inner, externally toothed fitting member rolling along the inner toothing of the first outer, internally toothed fitting member and an outer toothing of the second inner, externally toothed fitting member rolling along an inner toothing of a second outer, internally toothed fitting member. In order to produce a rotationally secure, positive-locking, materially engaging and/or non-positive-locking connection of the fitting members, the first inner, externally toothed fitting member has a formation and the second inner, externally toothed fitting member has another formation, with the formations being formed so as to correspond to each other, being connected at the front face in a positive-locking, materially engaging and/or non-positive-locking manner and being surrounded axially by the magnetic ring. This construction variant allows an electromechanically actuated planetary gear which runs in a particularly slow manner, such as a swash gear, with a high level of adjustment or positioning accuracy.

A first planetary gear formed from the first inner, externally toothed fitting member and the first outer, internally toothed fitting member has the same eccentricity as a second planetary gear formed from the second inner, externally toothed fitting member and the second outer, internally toothed fitting member.

During the method for operating a planetary gear arrangement, the individual magnetic coils of a magnetic ring are successively activated according to the invention so as to rotate in a peripheral direction of the magnetic ring so that the magnetic field thereof acts on an inner, externally toothed fitting member and imparts thereto a rotational swash movement, that swash movement being transmitted to an eccentric portion of an eccentric shaft and bringing about a rotation of the eccentric shaft. Consequently, it is possible to actuate the planetary gear arrangement in a direct electromechanical manner without additional gearing stages which are subjected to losses.

In an alternative embodiment of the method, the individual magnetic coils of the magnetic ring are successively activated so as to rotate in a peripheral direction of the magnetic ring so that the magnetic field thereof acts on the two connected, inner, externally toothed fitting members and imparts thereto a rotational swash movement along the inner toothing of a fitting member, with an outer toothing of the first inner, externally toothed fitting member rolling along an inner toothing of the first outer, internally toothed fitting member and the outer toothing of the second inner, externally toothed fitting member rolling along an inner toothing of a second outer, internally toothed fitting member, whereby the second outer, internally toothed fitting member is caused to move in rotation in relative terms in relation to the first outer, internally toothed fitting member.

A difference in the number of teeth and/or an absolute number of teeth of the inner and outer toothing may differ between the connected planetary gears. In particular, a variation of the absolute number of teeth and/or the difference in the number of teeth of the planetary gears brings about a different gear reduction of the planetary gear arrangement, with the connected planetary gears having the same eccentricity.

The invention is explained in greater detail with reference to the appended, schematic Figures.

In the drawings:

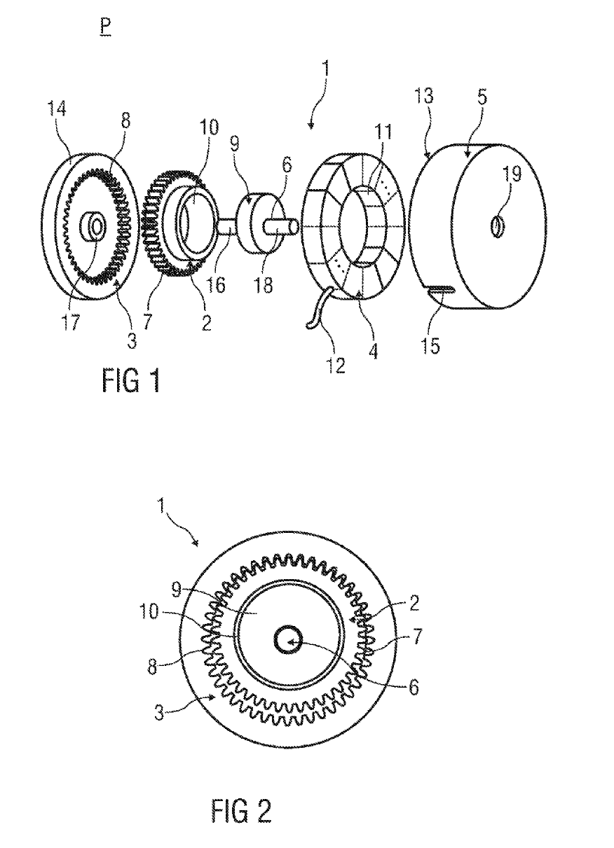

FIG. 1 is a schematic exploded view of a planetary gear arrangement having an electromechanically actuated planetary gear, in particular a swash gear,

FIG. 2 is a schematic side view of an electromechanically actuated planetary gear, in particular a swash gear,

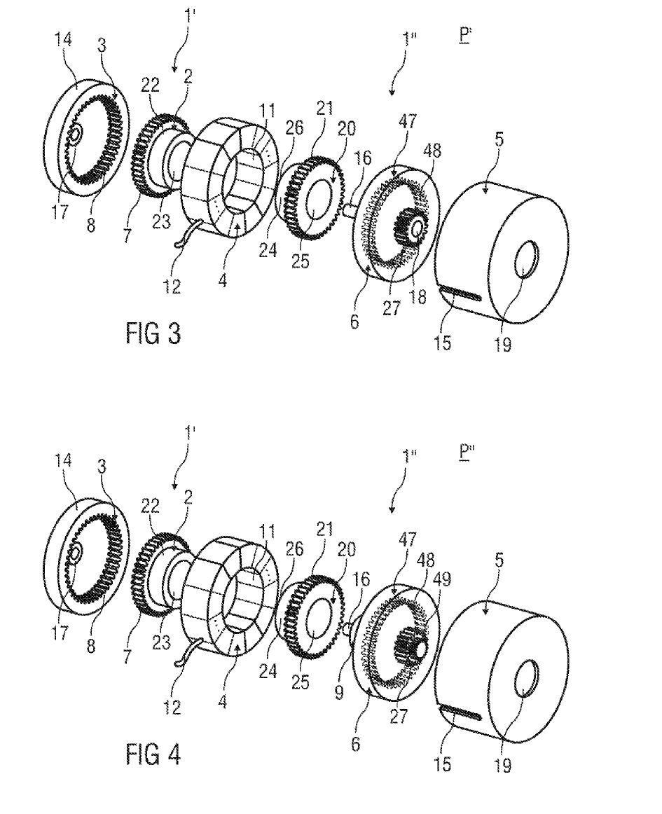

FIG. 3 is a schematic exploded view of a planetary gear arrangement comprising a combination of two planetary gears, in particular swash gears,

FIG. 4 is a schematic exploded view of an alternative construction variant of an electromechanically actuated combination of two planetary gears, in particular swash gears,

FIG. 5 schematically shows a use of an electromechanically actuated planetary gear, in particular a swash gear, as an inclination adjustment device for a vehicle seat,

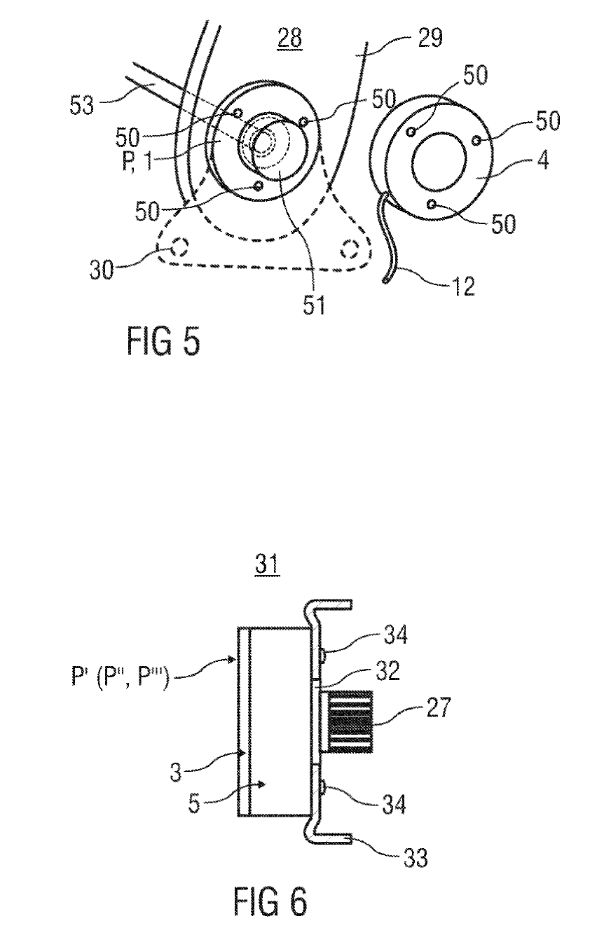

FIG. 6 is a schematic cross-section of an arrangement of an electromechanically actuated planetary gear, in particular a swash gear, as an inclination or height adjustment device for a vehicle seat face,

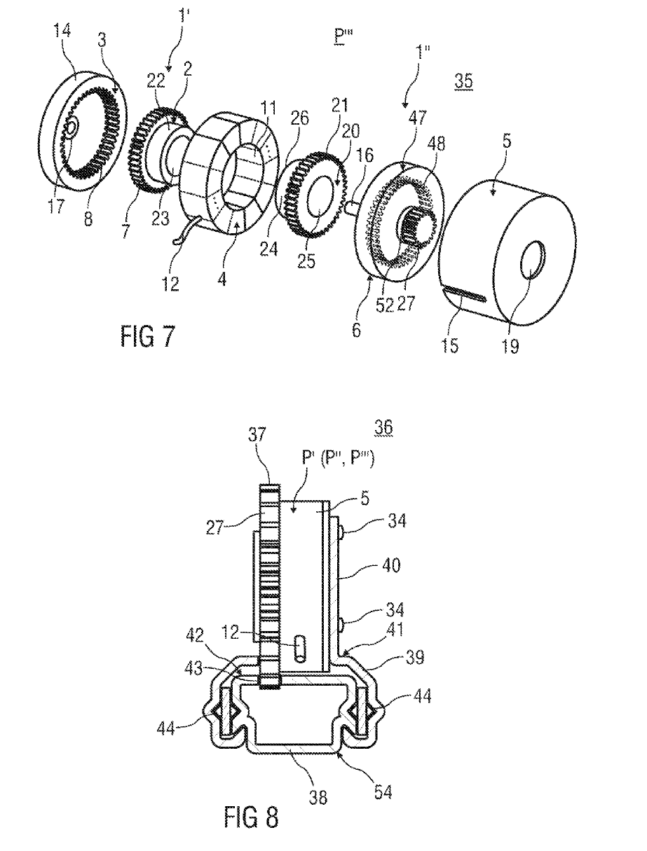

FIG. 7 is a schematic exploded view of an electromechanically actuated combination of two planetary gears, in particular swash gears, as a drive device of an inclination or height adjustment device for a vehicle seat face,

FIG. 8 is a schematic cross-section of a planetary gear arrangement of an electromechanically actuated planetary gear, in particular a swash gear, as a longitudinal adjustment device for a vehicle seat rail,

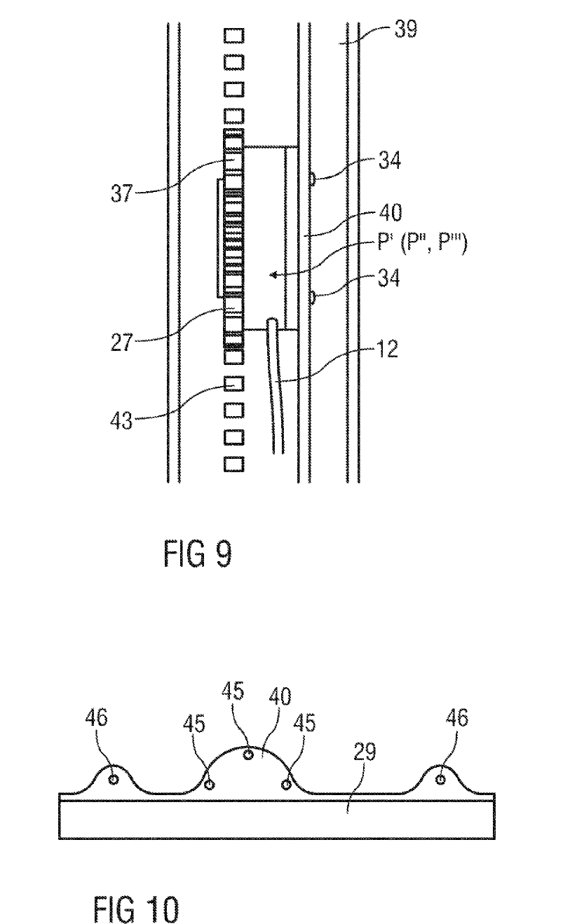

FIG. 9 is a schematic top view of a planetary gear arrangement of an electromechanically actuated planetary gear, in particular a swash gear, as a longitudinal adjustment device for a vehicle seat rail, and

FIG. 10 is a schematic side view of an upper rail for a vehicle seat rail.

Mutually corresponding members are indicated with the same reference numerals in all the Figures.

FIG. 1 is a schematic exploded view of a planetary gear arrangement P of an electromechanically actuated planetary gear. The planetary gear is illustrated in particular and by way of example as a swash gear 1 and is further described by way of example with reference to the swash gear 1. Such a swash gear 1 comprises at least an inner, externally toothed fitting member 2, an outer, internally toothed fitting member 3, a magnetic ring 4, a housing 5 and an eccentric shaft 6.

When the electromechanically actuated swash gear 1 is in the state mounted ready for operation, the inner, externally toothed fitting member 2 is arranged at least partially or in portions in the outer, internally toothed fitting member 3 in such a manner that an outer toothing 7 of the fitting member 2 can roll on an inner toothing 8 of the fitting member 3 in conventional manner. The outer toothing 7 and the inner toothing 8 have, for the same module, numbers of teeth which differ from each other by at least one tooth, with the number of teeth of the inner toothing 8 being greater than the number of teeth of the outer toothing 7.

The fitting members 3 and 2 are preferably produced by means of a conventional die-casting method or from fibre-reinforced plastics material and may, in alternative production methods, be formed with a non-cutting shaping method, for example, as a sheet metal stamping component.

During operation of the swash gear 1, the fitting member 2 is arranged rotatably in the fitting member 3 in a manner not illustrated and is retained, for example, by means of the housing 5.

The eccentric shaft 6 is in the form of a shaft, on which an eccentric portion 9 is preferably arranged centrally. The eccentric shaft 6 is arranged with a first shaft portion 16 rotatably in a bearing location 17 of the fitting member 3 and rotatably arranged with the eccentric portion 9 thereof in a central recess 10 of the fitting member 2. To that end, the recess 10 and the eccentric portion 9 are formed so as to correspond to each other.

The magnetic ring 4 is preferably formed from a plurality of magnetic coils which are arranged annularly beside each other in a peripheral direction. An inner periphery 11 of the magnetic ring 4 is formed so as to correspond to the fitting member 2 and the swash movement thereof along the inner toothing 8 of the fitting member 3, the term “swash movement” being intended to be understood to be a movement about an axis of rotation which changes its spatial position.

The magnetic ring 4 is preferably arranged so as to be fixed to a frame on the fitting member 3 at the end face.

In an embodiment which is not illustrated, the magnetic ring 4 surrounds the fitting member 3 at the outer side.

At least one multi-strand electrical connection line 12 is arranged on the magnetic ring 4.

The fitting members 2 and 3, the magnetic ring 4 and the eccentric shaft 6 are surrounded by the housing 5, with the housing 5 preferably being of bowl-like form and being retained with its open end 13 in a positive-locking, materially engaging and/or non-positive-locking manner on the fitting member 3. To that end, the open end 13 of the housing 5 is preferably formed so as to correspond to an outer periphery 14 of the fitting member 3.

A recess 15 is arranged in the housing 5 in order to introduce the connection lines 12 of the magnetic ring 4. The recess 15 is formed so as to correspond to the connection lines 12.

Another recess 19 is arranged in the housing 5 in order to introduce a second shaft portion 18 of the eccentric shaft 6. The recess 19 is formed so as to correspond to the second shaft portion 18 and may preferably be in the form of a conventional bearing location, for example, a sliding bearing or roller bearing, in a manner not illustrated in greater detail.

The second shaft portion 18 is preferably in the form of a conventional power take-off and may form a shaft/hub connection or a featherkey connection with other components which are not illustrated.

During operation of the electromechanically actuated swash gear 1, the individual magnetic coils of the magnetic ring 4 are activated so as to successively rotate in a peripheral direction of the magnetic ring 4 so that the magnetic field thereof acts on the inner, externally toothed fitting member 2 and imparts thereto a rotational swash movement. That swash movement is transmitted to the eccentric portion 9 of the eccentric shaft 6 and brings about a rotation of the eccentric shaft 6.

FIG. 2 is a schematic side view of the electromechanically actuated swash gear 1 according to FIG. 1 without a housing 5 or magnetic ring 4.

FIG. 3 is a schematic exploded view of an alternative embodiment of a planetary gear arrangement P′. The planetary gear arrangement P′ comprises an electromechanically actuated combination of two swash gears 1′ and 1″ which are formed from a pair of inner and outer fitting members 2, 3 or 20, 6, respectively. In this construction variant, a first inner, externally toothed fitting member 2 and a second inner, externally toothed fitting member 20 are retained rotatably in or on the fitting member 3 in a manner not illustrated. To that end, the fitting members 2 and 20 are connected to each other in a rotationally secure manner or rigidly.

The first inner, externally toothed fitting member 2 has at the end face thereof facing the second inner, externally toothed fitting member 20 a formation 22 in which a through-hole 23 is formed. The second inner, externally toothed fitting member 20 has at the end face thereof facing the first inner, externally toothed fitting member 2 a formation 24 in which another through-hole 25 is formed. An outer periphery 26 of the formation 24 of the second inner, externally toothed fitting member 20 is formed so as to correspond to the formation 22 of the first inner, externally toothed fitting member 2 so that the formation 22 of the first inner, externally toothed fitting member 2 and the formation 24 of the second inner, externally toothed fitting member 20 can be arranged on each other at the end face in a positive-locking, materially engaging and/or non-positive-locking manner. The inner, externally toothed fitting members 2 and 20 are thereby arranged so as to be rotationally secure relative to each other during operation and are in active connection with each other.

The first inner, externally toothed fitting member 2 is arranged in the outer, internally toothed fitting member 3 in such a manner that an outer toothing 7 of the fitting member 2 can roll on the inner toothing 8 of the fitting member 3 in the manner already described.

In this embodiment, the eccentric shaft 6 comprises a first shaft portion 16 which is arranged partially inside the bearing location 17 and inside the through-holes 23 and 25 of the inner, externally toothed fitting members 2 and 20. At the end face, a second outer, internally toothed fitting member 47 is arranged on the eccentric shaft 6 in a rotationally secure manner at the end of the first shaft portion 16 opposite the bearing location 17 in the region of the inner, externally toothed fitting member 20. That second outer, internally toothed fitting member 47 is arranged on the eccentric shaft 6 in a rotationally secure manner and is supported with low friction in the housing 5 in a manner which is not illustrated in greater detail.

When the planetary gear arrangement P′ which is actuated electromechanically and which comprises the combination of two swash gears 1′ and 1″ is in the state mounted ready for operation, the second inner, externally toothed fitting member 20 is arranged at least partially or in regions in the second outer, internally toothed fitting member 47 in such a manner that an outer toothing 21 of the fitting member 20 can roll on an inner toothing 48 of the fitting member 47 in conventional manner, resulting in relative movement between the fitting members 20 and 47. The outer toothing 21 and the inner toothing 48 have, for the same module, numbers of teeth which differ from each other by at least one tooth, with the number of teeth of the inner toothing 48 being greater than the number of teeth of the outer toothing 21.

A difference in the number of teeth and/or an absolute number of teeth of the inner toothings 8, 48 and outer toothings 7, 21 may differ between the connected swash gears 1′ and 1″. In particular, a variation in the absolute number of teeth and/or the difference in the number of teeth of the swash gears 1′ and 1″ brings about a different gear reduction of the planetary gear arrangement P′, with the connected swash gears 1′ and 1″ having the same eccentricity.

During operation of the planetary gear arrangement P′, the fitting member 47 is rotatably retained in the fitting member 20 in a manner which is not illustrated.

The magnetic ring 4 surrounds or encloses the formation 24 of the second internally toothed fitting member 20 and the formation 22 of the first internally toothed fitting member 2 axially so that the fitting members 2 and 20 are arranged on the magnetic ring 4 at the end face, respectively.

During operation of the electromechanically actuated planetary gear arrangement P′, the individual magnetic coils of the magnetic ring 4 are activated so as to successively rotate in a peripheral direction of the magnetic ring 4 so that the magnetic field thereof acts on the two connected inner, externally toothed fitting members 2 and 20 and imparts thereto a rotational swash movement. The outer toothing 7 of the first inner, externally toothed fitting member 2 rolls along the inner toothing 8 of the first outer, internally toothed fitting member 3.

The outer toothing 21 of the second inner, externally toothed fitting member 20 rolls along the inner toothing 48 of the second outer, internally toothed fitting member 47. The second outer, internally toothed fitting member 47 is thereby urged into a rotational relative movement in relation to the first outer, internally toothed fitting member 3.

This construction variant allows an electromechanically actuated planetary gear arrangement P′ which runs particularly slowly.

In another embodiment, a conventional spur gear 27 may be arranged as a power take-off on or at the eccentric shaft 6, in particular the second shaft portion 18 or at the end face on the second outer, internally toothed fitting member 47.

In another embodiment (not illustrated), two conventional spur gears 27 may be arranged on the eccentric shaft 6 as a power take-off and are preferably different from each other in terms of the number of teeth and/or the module.

FIG. 4 is a schematic exploded view of an alternative construction variant of an electromechanically actuated planetary gear arrangement P″ comprising a combination of two swash gears 1′ and 1″. This construction variant substantially corresponds to the construction variant according to FIG. 3 with the difference that an eccentric portion 9 is arranged on the eccentric shaft 6. This eccentric shaft 9 is arranged inside the through-holes 23 and 25 of the inner, externally toothed fitting members 2 and 20 and is formed so as to correspond to those through-holes 23 and 25.

The eccentric portion 9 is connected to another spur gear 49 in a manner which is not illustrated in greater detail. To that end, for example, the second shaft portion 18 extends through the second outer, internally toothed fitting member 47, with the second outer, internally toothed fitting member 47 being supported rotatably on the second shaft portion 18.

The second outer, internally toothed fitting member 47 and the spur gear 27 are connected to each other in a rotationally secure manner or are in the form of an integral component.

Furthermore, the first shaft portion 16 and the second shaft portion 18 and the eccentric portion 9 and another spur gear 49 are connected to each other in a rotationally secure manner or are in the form of an integral component.

During operation, the eccentric portion 9 converts the swash movements of the inner, externally toothed fitting members 2 and 20 into a rotational movement so that the additional spur gear 49 rotates at the speed of the inner, externally toothed fitting members 2 and whereas the spur gear 27 rotates at the comparatively slower speed of the second outer, internally toothed fitting member 47. In that manner, a geared motor having two different power take-off speeds is possible.

FIG. 5 schematically shows a use of the electromechanically actuated swash gear 1 as an inclination adjustment device 28 for a vehicle seat which is not illustrated in greater detail. Such an inclination adjustment device 28 allows a pivot movement of a backrest 29 relative to a seat member (not illustrated) of the vehicle seat. The inclination adjustment device 28 can be arranged on the seat member by means of the connection portion 30.

The inclination adjustment device 28 is preferably a conventional inclination adjustment device, with the inner toothing 8 of the fitting member 3 rolling on the outer toothing 7 of the fitting member 2 during driving about a pivot axis of the inclination adjustment device 28, whereby pivoting of the fitting member 3 fixed to the backrest in relation to the fitting member 2 fixed to the seat member is achieved, which pivoting corresponds to the difference in the number of teeth.

In an alternative embodiment, the fitting member 3 may be formed so as to be fixed to the seat member, whereas the fitting member 2 is fixed to the backrest.

The magnetic ring 4 may be arranged on such a conventional inclination adjustment device 28 at the outer side, for example, in place of a covering cap which is not illustrated or in addition to a covering cap, and may be operated in the manner already described. An existing swash gear may thereby readily be actuated electromechanically.

Fixing and positioning portions 50 are formed both on the magnetic ring 4 and on the inclination adjustment device 28 in order to arrange the magnetic ring 4 on the inclination adjustment device 28 in a rotationally secure manner.

The inner, externally toothed fitting member 2 is extended by means of a sleeve-like formation 51 in such a manner that the sleeve-like formation 51 is surrounded by the magnetic ring 4 so that it acts on the inner, externally toothed fitting member 2 during operation.

During operation of the inclination adjustment device 28, the sleeve-like formation 51 and therefore the inner, externally toothed fitting member 2 are caused to rotate in the manner described.

A vehicle seat generally comprises an inclination adjustment device 28 at each side. The devices are connected to each other by means of a transmission and connection rod 53 so that actuation of the inclination adjustment device 28 at one side of the vehicle seat is transmitted to the inclination adjustment device 28 of the other side.

Alternatively, a separate magnetic ring 4 may be arranged on each of the inclination adjustment devices 28.

FIG. 6 is, by way of example, a schematic cross-section of one of the planetary gear arrangements P′ to

P″ as an inclination or height adjustment device 31 for a vehicle seat face which is not illustrated.

During operation of the planetary gear arrangement P′ or P″ as part of the inclination or height adjustment device 31, a spur gear 27 is arranged on the eccentric shaft 6. The planetary gear arrangement P′ or P″ is arranged in the region of a recess 32 on a conventional seat pad lateral member 33 of a vehicle seat face. The associated housing 5 of the planetary gear arrangement P′ or P″ is fixed to the seat pad lateral member 33 by means of a plurality of conventional fixing means 34, for example, screws. The spur gear 27 protrudes through the recess 32 and is in active connection, in order to actuate the remaining members of the inclination or height adjustment device 31, with a transmission means which is not illustrated and which is in the form of, for example, a toothed wheel or a toothed rod.

FIG. 7 is a schematic exploded view of another embodiment of a planetary gear arrangement P′″ comprising an electromechanically actuated combination of two swash gears 1′ and 1″ as a drive device 35 of the inclination or height adjustment device 31 for a vehicle seat face. This drive device 35 substantially corresponds to the construction variant described in FIG. 3 of the electromechanically actuated combination of two swash gears 1′ and 1″ with the difference that a bearing portion 52 is arranged between the spur gear 27 and the second outer, internally toothed fitting member 47, by means of which bearing portion 52 the eccentric shaft 6 is supported in the housing 5 with minimal friction. The bearing portion 52 is arranged in the region of the additional recess 19 of the housing 5, with the recess 19 being in the form of a sliding bearing or comprising a roller bearing.

FIG. 8 is a schematic cross-section of one of the planetary gear arrangements P′ to P′″ of the electromechanically actuated swash gear 1 as a longitudinal adjustment device 36 for a vehicle seat rail 54. During operation of the planetary gear arrangement P′ to P′″, as part of the longitudinal adjustment device 36, there is arranged on the eccentric shaft 6 a spur gear 27 which has an outer diameter which is greater than an outer diameter of the housing 5. At least the individual teeth 37 of the spur gear 27 thereby project beyond the electromechanically actuated planetary gear arrangements P′ to P′″.

The longitudinal adjustment device 36 is preferably in the form of a conventional longitudinal adjustment device for vehicle seats which comprises a lower rail 38 and an upper rail 39. The upper rail 39 is arranged in the lower rail 38 or engages therein, with the upper rail 39 being formed so as to correspond to the lower rail 38. The lower rail 38 is arranged so as to be fixed to a frame on a vehicle bodywork (not illustrated) and the upper rail 39 is arranged so as to be longitudinally displaceable in the lower rail 38 by means of conventional rolling elements 44.

Retention elements 40 which are illustrated in greater detail in FIG. 9 are formed on the upper side 41 of the upper rail 39. The electromechanically actuated planetary gear arrangement P′ to P′″ is fixed to the retention element 40 and consequently to the upper rail 39 in a manner fixed to a frame by means of a plurality of conventional fixing means 34, for example, screws. The planetary gear arrangement P′ to P′″ is arranged on the upper rail 39 in such a manner that the spur gear 27 engages in an upper side 42 of the lower rail 38. In order to produce an active connection between the spur gear 27 and the lower rail 38, a row 43 of slot-like recesses or punched formations in the manner of a toothed rod is formed in the longitudinal direction on the lower rail, which recesses or formations are formed so as to correspond to the teeth 37 of the spur gear 27. A rotational movement of the gear 27 is thereby converted into a translational movement of the upper rail 39.

FIG. 9 is a schematic top view of an arrangement of the planetary gear arrangements P′ to P′″ as a longitudinal adjustment device 36 for a vehicle seat rail 54.

FIG. 10 is a schematic side view of the upper rail 39 for a vehicle seat rail 54. The fixing portion 46 for a height adjustment device (not illustrated) is arranged or formed on that upper rail 39. Furthermore, a fixing portion for the planetary gear arrangements P′ to P′″ is formed and has a plurality of through-holes 45 which serve to arrange fixing means 34 and which are formed accordingly so as to correspond to the fixing means 34. Furthermore, a plurality of conventional fixing portions 46 which allow, for example, the vehicle seat to be fixed in position, are arranged on the upper side 41 of the upper rail 39.

### LIST OF REFERENCE NUMERALS

P to P′″ Planetary gear arrangement
1, 1′, 1″ Electromagnetically actuated swash gear
2 Inner, externally toothed fitting member
3 Outer, internally toothed fitting member
4 Magnetic ring
5 Housing
6 Eccentric shaft
7 Outer toothing
8 Inner toothing
9 Eccentric portion
10 Recess
11 Inner periphery
12 Connection line
13 End
14 Outer periphery
15 Recess
16 First shaft portion
17 Bearing location
18 Second shaft portion
19 Additional recess
20 Second inner, externally toothed fitting member
21 Outer toothing
22 Formation
23 Through-hole
24 Formation
25 Through-hole
26 Outer periphery
27 Spur gear
28 Inclination adjustment device
29 Backrest
30 Connection portion
31 Inclination or height adjustment device
32 Recess
33 Seat pad lateral portion
34 Fixing means
35 Drive device
36 Longitudinal adjustment device
37 Tooth
38 Lower rail
39 Upper rail
40 Retention element
41 Upper side of upper rail
42 Upper side of lower rail
43 Row
44 Rolling element
45 Through-hole
46 Fixing portion
47 Second outer, internally toothed fitting member
48 Inner toothing
49 Additional spur gear
50 Fixing and positioning portion
51 Sleeve-like formation
52 Bearing portion
53 Transmission and connection rod
54 Vehicle seat rail

1. A planetary gear arrangement for a seat adjustment mechanism, which arrangement comprises at least an inner, externally toothed fitting member and an outer, internally toothed fitting member which can be pivoted relative to each other about a pivot axis, with the inner, externally toothed fitting member being arranged in the outer, internally toothed fitting member in such a manner that an outer toothing of the inner, externally toothed fitting member rolls on an inner toothing of the outer, internally toothed fitting member,
wherein a plurality of electrical magnetic coils are arranged annularly on the outer, internally toothed fitting member, which coils can be activated so as to rotate alternately in a peripheral direction of the outer, internally toothed fitting member so that the magnetic field thereof acts on the inner, externally toothed fitting member and causes this member to move in rotation relative to the outer, internally toothed fitting member.

2. The planetary gear arrangement as claimed in claim 1, wherein the plurality of magnetic coils are in the form of a magnetic ring.

3. The planetary gear arrangement as claimed in claim 2, wherein an inner periphery of the magnetic ring is formed so as to correspond to the fitting member and the swash movement thereof along the inner toothing of the fitting member.

4. The planetary gear arrangement as claimed in claim 2, wherein the magnetic ring is arranged at the front face on the fitting member so as to be fixed to a frame.

5. The planetary gear arrangement as claimed in claim 2, wherein, the magnetic ring surrounds the fitting member at the outer side.

6. The planetary gear arrangement as claimed in claim 2, wherein the fitting members, the magnetic ring and the eccentric shaft are surrounded by a housing which is of bowl-like form and which is retained on the fitting member with the open end thereof in a positive-locking, materially engaging and/or non-positive-locking manner.

7. The planetary gear arrangement as claimed in claim 1, wherein a first inner, externally toothed fitting member and a second inner, externally toothed fitting member are connected in a rotationally secure manner, with the outer toothing of the first inner, externally toothed fitting member rolling along the inner toothing of the first outer, internally toothed fitting member and an outer toothing of the second inner, externally toothed fitting member rolling along an inner toothing of a second outer, internally toothed fitting member.

8. The planetary gear arrangement as claimed in claim 7, wherein in order to produce a rotationally secure, positive-locking, materially engaging and/or non-positive-locking connection between the fitting members, the first inner fitting member has a formation and the second inner fitting member has a formation, with the formations being formed so as to correspond to each other, being connected at the front face in a positive-locking, materially engaging and/or non-positive-locking manner and being surrounded axially by the magnetic ring.

9. A method for operating a planetary gear arrangement for a seat adjustment mechanism as claimed in claim 1, wherein the individual magnetic coils of a magnetic ring are successively activated so as to rotate in a peripheral direction of the magnetic ring so that the magnetic field thereof acts on an inner, externally toothed fitting member and imparts thereto a rotational swash movement along an inner toothing of a first outer, internally toothed fitting member, that swash movement being transmitted to an eccentric portion of an eccentric shaft and bringing about a rotation of the eccentric shaft.

10. The method as claimed in claim 9, wherein the individual magnetic coils of the magnetic ring are successively activated so as to rotate in a peripheral direction of the magnetic ring so that the magnetic field thereof acts on the two connected, inner, externally toothed fitting members and imparts thereto a rotational swash movement, with an outer toothing of the first inner, externally toothed fitting member rolling along an inner toothing of the first outer, internally toothed fitting member and an outer toothing of a second inner, externally toothed fitting member rolling along an inner toothing of a second outer, internally toothed fitting member, whereby the second outer, internally toothed fitting member is caused to move in rotation in relation to the first outer, internally toothed fitting member.
